(19) United States
(12) Patent Application Publication
(10) Pub. No.: US 2013/0252037 A1
(43) Pub. Date: Sep. 26, 2013

(54) BATTERY AND BATTERY SYSTEM

(71) Applicant: MITSUBISHI HEAVY INDUSTRIES, LTD., Tokyo (JP)

(72) Inventor: Daisuke Chiba, Tokyo (JP)

(73) Assignee: MITSUBISHI HEAVY INDUSTRIES, LTD., Tokyo (JP)

(21) Appl. No.: 13/785,786

(22) Filed: Mar. 5, 2013

(30) Foreign Application Priority Data
Mar. 22, 2012 (JP) 2012-065229

(51) Int. Cl. H01M 2/12

(52) U.S. Cl. CPC H01M 2/1241
USPC 429/53

(57) ABSTRACT

A battery includes a valve unit which is disposed on a first surface of a battery container to be broken when a gas pressure in the battery container increases to a predetermined value or greater, so as to guide a gas in the battery container in a direction inclined at a predetermined angle with respect to a normal direction of the first surface to discharge the gas to the outside.

### BACKGROUND OF THE INVENTION

1. Field of the Invention

The present invention relates to a battery, and particularly, to a safety valve which is provided in the battery.

Priority is claimed on Japanese Patent Application No. 2012-065229, filed on Mar. 22, 2012, the content of which is incorporated herein by reference.

2. Description of Related Art

As batteries, there are primary batteries which perform only discharge and secondary batteries which perform discharge and charge. Particularly, in recent years, attention has been paid to lithium secondary batteries having features such as a high energy density, a high output, and a long lifespan as secondary batteries. Generally, the lithium secondary batteries have a configuration in which a laminated electrode body having a positive electrode plate and a negative electrode plate laminated with a separator interposed therebetween is sealed in a battery container together with an electrolyte and the like.

In batteries such as lithium secondary batteries, for example, there are concerns that when problems such as a short or an overcharge occur, a large amount of high-temperature gas is generated in the battery container due to the rapid evaporation of the electrolyte and the like and an internal pressure of the battery container rapidly increases, whereby a battery container body explodes.

Therefore, generally, a lid of the battery container is provided with a safety valve for discharging the gas in the battery container to the outside when the internal gas pressure of the battery container increases to a predetermined value or greater, to prevent the battery container from exploding (for example, see Japanese Unexamined Patent Application, First Publication No. 2005-332700).

However, since conventional batteries such as the battery described in Japanese Unexamined Patent Application, First Publication No. 2005-332700 have a safety valve provided according to the surface shape of the lid, the discharge direction of the gas when a problem occurs in the battery is determined as a direction facing the surface of the lid. That is, the battery container generally has a rectangular parallelepiped or cylindrical object shape, the bottom surface and the upper surface thereof are parallel to each other with respect to the horizontal plane, and the lid positioned on the upper surface of the battery container is provided with a safety valve. In addition, the gas generated in the battery container is discharged in a normal direction of the horizontal plane (for example, direction of gravity) from the safety valve. Therefore, for example, in the case in which batteries which are provided with a safety valve on a lid positioned on the upper surface of the battery container are disposed on each shelf in a container to constitute one large-capacity electric storage device, when a safety valve of a battery on a certain shelf operates, a high-temperature gas is directly discharged to an upper shelf above the battery. As a result, there is a possibility that a chain reaction may be caused in which a battery disposed on the upper shelf is also heated and the internal pressure thereof also increases, whereby a safety valve operates.

### SUMMARY OF THE INVENTION

The invention provides a battery which takes the discharge direction of a gas discharged from a safety valve into account.

According to a first aspect of the present invention, a battery includes: a valve unit which is disposed on a first surface of a battery container to be broken when the gas pressure in the battery container increases to a predetermined value or greater, so as to guide a gas in the battery container in a direction inclined at a predetermined angle with respect to a normal direction of the first surface to discharge the gas to the outside.

According to such a configuration, the battery has the valve unit (safety valve) which guides the gas generated in the battery container in a direction inclined at a predetermined angle with respect to a normal direction of the first surface of the battery container to discharge the gas to the outside. Accordingly, even when various objects are present in a direction facing the first surface provided with the safety valve of the battery when the battery is disposed, it is possible to avoid direct discharge of the gas to the objects. As a result, for example, as described above, in the case in which batteries which are provided with a safety valve on a lid positioned on the upper surface of the battery container are disposed on each shelf in a container to constitute one large-capacity electric storage device, even when a safety valve of a battery on a certain shelf operates, a high-temperature gas is not directly discharged to an upper shelf above the battery. As a result, it is possible to prevent a chain reaction in which a battery disposed on the upper shelf is also heated and the internal pressure thereof also increases, whereby a safety valve is caused to operate.

According to a second aspect of the present invention, the valve unit includes a break part which seals a through hole formed on the first surface and is broken when the gas pressure in the battery container increases to a predetermined value or greater, and a guide which is formed into a tubular shape, protruding from a peripheral edge of the break part toward the outside of the battery container, in which an angle between central axes of both end surfaces is inclined at a predetermined angle, and guides the gas in the direction inclined at a predetermined angle to discharge the gas to the outside when the break part is broken.

According to a third aspect of the present invention, the guide is detachably joined to the break part.

According to a fourth aspect of the present invention, the guide is rotatable around the central axis of the first end surface.

According to a fifth aspect of the present invention, a battery system includes: a battery module which is constituted by a plurality of batteries, each of which is provided with a valve unit which is disposed on a first surface of a battery container to be broken when the gas pressure in the battery container increases to a predetermined value or greater, so as to guide a gas in the battery container in a direction inclined at a predetermined angle with respect to a normal direction of the first surface to discharge the gas to the outside; and a fireproof plate which is disposed on a side of the battery module. The respective valve units of the plurality of batteries guide the gas generated in the battery container in a direction inclined at a predetermined angle toward the fireproof plate to discharge the gas to the outside.

According to a sixth aspect of the present invention, the respective valve units of the plurality of batteries are different from each other in terms of the direction in which the gas is discharged to the outside according to a distance to the fireproof plate.

According to the battery constituted as described above, it is possible to avoid direct discharge of a gas to various objects positioned in a direction facing a battery lid provided with a safety valve even when the gas is generated from the safety valve of the battery.

### BRIEF DESCRIPTION OF THE DRAWINGS

FIG. 1 illustrates a schematic perspective view of a battery according to an embodiment.

FIG. 2 is a diagram for illustrating elements constituting a valve unit in the battery according to the embodiment.

FIG. 3A is a cross-sectional view of the valve unit in the battery according to the embodiment, illustrating a cross-section taken along the line A-A′ of FIG. 1.

FIG. 3B is a cross-sectional view of the valve unit in the battery according to the embodiment, illustrating a cross-section taken along the line B-B′ of FIG. 1.

FIG. 4A is a reference diagram for the case in which a battery module with a plurality of conventional batteries combined together is disposed on each shelf

FIG. 4B is a reference diagram for the case in which a battery module with a plurality of batteries according to the embodiment combined together is disposed on each shelf.

FIG. 5 is a reference diagram for the case in which a battery module with a plurality of batteries having different valve units combined together is disposed on each shelf.

FIG. 6 illustrates a cross-sectional view of Modified Example 1 of the valve unit of the battery according to the embodiment.

FIG. 7 illustrates a cross-sectional view of Modified Example 2 of the valve unit of the battery according to the embodiment. FIG. 8A is a schematic view of Modified Example 3 of the valve unit of the battery according to the embodiment, and is a front view of the valve unit viewed from a break surface.

FIG. 8B is a schematic view of Modified Example 3 of the valve unit of the battery according to the embodiment, and is a cross-sectional view in a direction perpendicular to the break surface of the valve unit.

FIG. 9 illustrates a cross-sectional view of Modified Example 4 of the valve unit of the battery according to the embodiment.

### DETAILED DESCRIPTION OF THE INVENTION

Hereinafter, preferred embodiments for carrying out the present invention will be described referring to the drawings. In the following embodiments, a lithium secondary battery will be described as an example of a battery. In addition, in the respective drawings, from the viewpoint of clarity, the dimensions and scale of the shapes of units constituting the battery may be different from the actual dimensions and scale thereof.

### First Embodiment

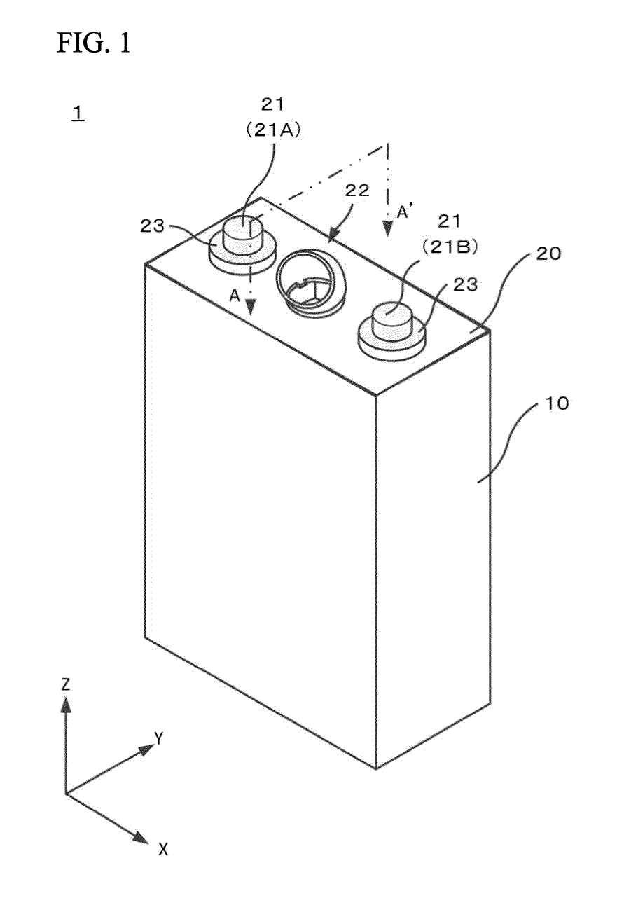

FIG. 1 illustrates a schematic perspective view of a battery 1 according to a first embodiment of the present invention.

The battery 1 according to the first embodiment of the present invention is as shown in FIG. 1, and is constituted by a battery container body 10 and a battery lid 20 which covers an opening of the battery container body 10 and has two electrode terminals 21 (positive electrode terminal 21A and negative electrode terminal 21B) and a safety valve (valve unit) 22 disposed thereon. Hereinafter, the battery container body 10 formed integrally with the battery lid 20 will be referred to as the “battery container”.

The battery container body (body of the battery container) 10 is an angular container which accommodates an electrode plate, that is, a laminated electrode body (not shown) having a positive electrode plate and a negative electrode plate laminated with a separator interposed therebetween, together with an electrolyte and the like. The battery container body is made of, for example, a metallic material such as an aluminum alloy. A positive electrode tab is formed at one end of the positive electrode plate, and a positive electrode lead electrically connects the positive electrode tab and the positive electrode terminal 21A to each other. In addition, a negative electrode tab is formed at one end of the negative electrode plate, and a negative electrode lead electrically connects the negative electrode tab and the negative electrode terminal 21B to each other. By virtue of the above-described configuration, the battery 1 can take a current out of the positive electrode terminal 21A and the negative electrode terminal 21B.

As shown in FIG. 1, the battery lid 20 is a flat plate-shaped lid for covering and sealing the battery container body 10. Similarly to the battery container body 10, the battery lid is made of, for example, a metallic material such as an aluminum alloy. In addition, the battery lid 20 is provided with through holes, each of which is for passing the positive electrode terminal 21A and the negative electrode terminal 21B therethrough. An insulating resin (sealing member) 23 is provided to fill in the gaps of the positive electrode terminal 21A and the negative electrode terminal 21B which pass through the through holes so as not to be brought into contact therewith, respectively, and to seal the gaps. The laminated electrode body and the like are accommodated in the battery container body 10, and then the outer edge of the battery lid 20 is welded to the peripheral edge of the opening of the battery container body 10 (for example, laser welding) to seal the battery container body 10.

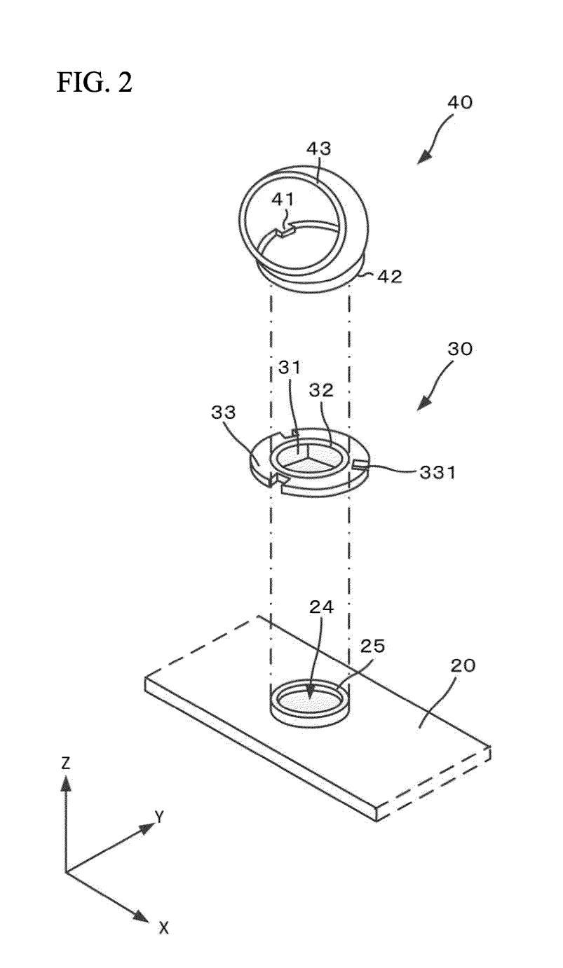

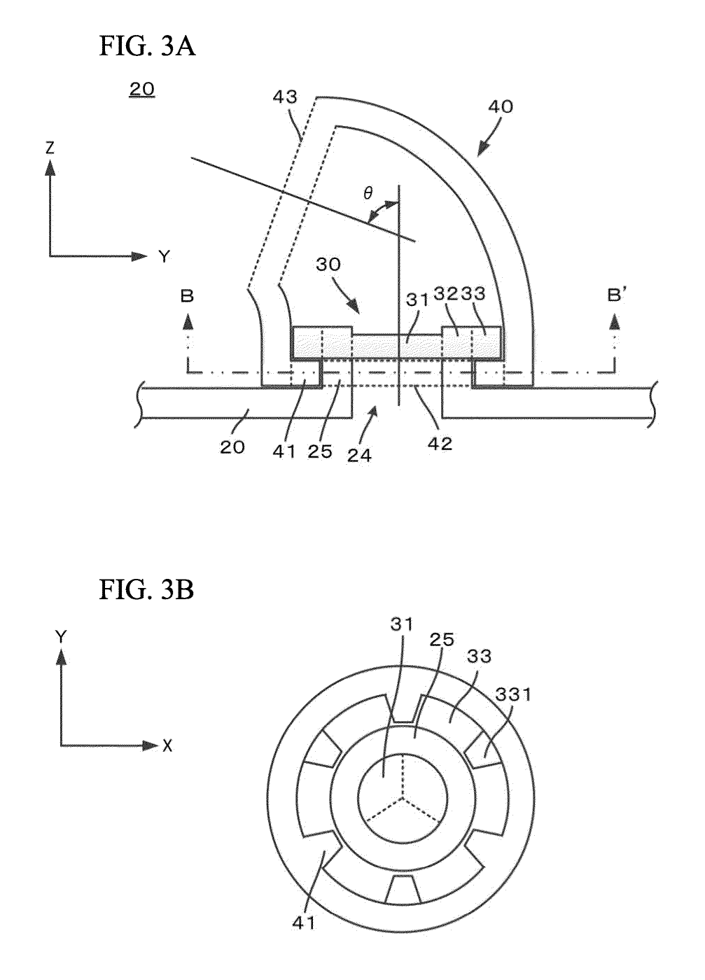

Here, referring to FIGS. 2, 3A, and 3B, the structure of a valve unit 22 in the embodiment will be described in detail. FIG. 2 is a diagram for illustrating elements (break part 30 and guide 40) constituting the valve unit 22, and FIG. 3A illustrates a cross-sectional view (cross-sectional view taken along the line A-A′ of FIG. 1) for the case in which the valve unit 22 is formed integrally with the battery lid 20. In the following embodiments, descriptions will be provided appropriately using an XYZ orthogonal coordinate system. In the battery 1, a direction perpendicular from the bottom surface of the battery container body 10 (surface opposed to the battery lid 20) shown in FIG. 1 toward the battery lid 20 is set as a Z-axis direction, a direction along a side of the battery lid 20 in a longitudinal direction, which is perpendicular to the Z-axis direction, is set as a X-axis direction, and a direction which is perpendicular to the X-axis direction and the Z-axis direction (direction along a side perpendicular to the horizontal direction of the battery lid 20) is set as a Y-axis direction.

The valve unit 22 is a rupturing-type safety valve for preventing the battery container itself from exploding by the generation of a large amount of a high-temperature gas in the battery container due to the rapid evaporation of the electrolyte and the like, and by a rapid increase of an internal pressure when a short or an overcharge occur in the battery 1.

As shown in FIG. 2, the valve unit 22 is constituted by a break part 30 for sealing a through hole 24 formed on a surface (on a first surface) of the battery lid 20 and to break when the gas pressure in the battery container increases to a predetermined value or greater, and a guide 40 which protrudes from the peripheral edge of the break part 30 toward the outside of the battery container and guides a gas in a direction inclined at a predetermined angle to discharge the gas to the outside when the break part 30 is broken.

The break part 30 has a break surface 31 which is broken when the gas pressure in the battery container increases to a predetermined value or greater, a first joining unit 32 for joining to the battery lid 20, and a second joining unit 33 for joining to the guide 40.

The break surface 31 is a part which covers the through hole 24 of the battery lid 20 and is broken when the gas pressure in the battery container increases to a predetermined value or greater. The material, shape, and break conditions of the break surface 31 may be the same as those of a break surface of a conventional safety valve.

The first joining unit 32 is a part which is provided along the outer periphery of the break surface 31 to be joined to a protrusion 25, protruding from the peripheral edge of the through hole 24 of the battery lid 20 to the outside of the battery container (+Z direction), by welding. In this part, the joining by welding can be performed using various kinds of methods such as laser welding and ultrasonic welding.

The second joining unit 33 is a part which is provided along the outer periphery of the first joining unit 32 to be joined to the guide 40, and has a recess (notch) 331 at a predetermined position on the outer periphery. The recess 331 allows a height 41 of the guide 40 provided at a position corresponding to the recess 331 to be passed therethrough in the Z-axis direction when the second joining unit 33 of the break part 30 and the height (joining unit) 41 of the guide 40 are joined to each other.

As shown in FIGS. 2 and 3A, the guide 40 is formed into a tubular shape in which a first end surface 42 facing and being open to the break part 30 and a second end surface 43 facing and being open to the outside communicate with each other, and has the height 41 at a predetermined position at the inner peripheral edge of the first end surface 42 so as to correspond to the recess 331 of the second joining unit 33. The guide 40 is preferably made of a material capable of withstanding the gas temperature at the time of discharging the gas, such as a steel plate or ceramic. In addition, the guide 40 is formed so that the area of the opening of the first end surface 42, the area of the gas flow channel in the body part of the tubular shape communicating the first end surface with the second end surface, and the area of the opening of the second end surface 43 are substantially the same as each other so as to easily discharge the gas generated in the battery container to the outside when the break part 30 is broken. When the guide 40 is formed as described above, the gas can be smoothly discharged to the outside and the gas discharged to the outside has directivity, and thus the gas can be discharged toward a desired position in a desired direction. The embodiment is not limited to the case in which the area of the opening of the first end surface 42, the area of the gas flow channel, and the area of the opening of the second end surface 43 are substantially the same as each other, and for example, the area of the opening of the second end surface 43 may be greater than the area of the opening of the first end surface 42 and the area of the gas flow channel may be increased from the first end surface 42 toward the second end surface 43.

In joining to the break part 30, the guide 40 can be joined thereto by passing the height 41 through the notch 331 of the second joining unit 33 of the break part 30 in the Z-axis direction and by then rotating the guide 40 around the Z axis (that is, the guide is rotated so that the height 41 and the second joining section 33 are positioned at different positions on the X-Y plane as shown in FIG. 3B). The protrusion 25 is provided at the peripheral edge of the through hole 24 of the battery lid 20 to provide the break part 30 and the guide 40 as described above, whereby the guide 40 itself can be detachable from the break part 30. When the guide 40 is detachable from the break part 30, that is, the battery lid 20, it is possible to appropriately judge the necessity for the attachment of the guide according to various causes such as a position at which the battery 1 is disposed and a space for providing the guide 40.

In addition, since the guide 40 guides the gas in a direction inclined at a predetermined angle to discharge the gas to the outside when the break part 30 is broken, the angle between a central axis (Z axis) of the first end surface 42 and a central axis of the second end surface 43 is inclined at a predetermined angle θ as shown in FIG. 3A. The predetermined angle θ can be appropriately set in the range of, for example, 0°<θ≦90° so that the gas is not directly discharged in a direction (Z-axis direction) facing the battery lid according to the position at which the battery 1 is disposed.

According to the battery 1 of the embodiment constituted as described above, the battery has the valve unit (safety valve) 22 which guides the gas generated in the battery container in a direction inclined at a predetermined angle with respect to a normal direction of the surface (first surface) of the battery lid 20 of the battery container to discharge the gas to the outside. Accordingly, even when various objects are present in a direction facing the surface of the battery lid 20 of the battery 1 when the battery 1 is disposed, it is possible to avoid direct discharge of the gas to the objects.

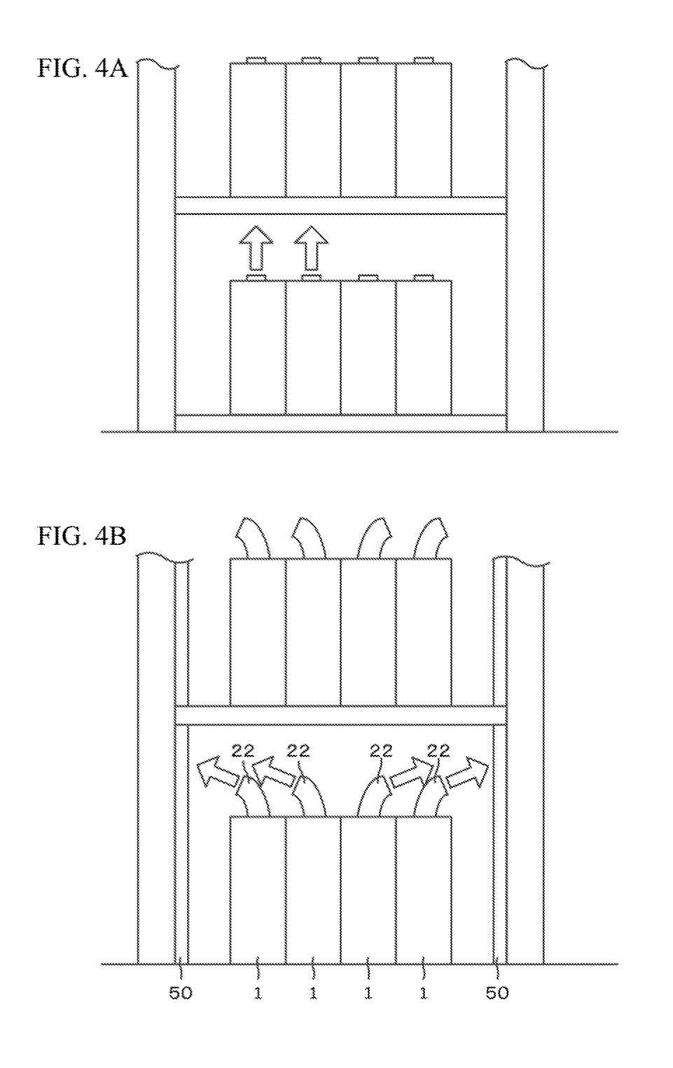

Specifically, for example, the invention is effective for the case in which a battery module constituted by a plurality of batteries 1 is disposed on each shelf of a container to constitute one large-capacity electric storage device as shown in FIG. 4B. That is, in the case in which a break surface of a safety valve is provided parallel to a surface of a battery lid 20 as in the case of the conventional batteries, when a safety valve (valve unit) of a battery 1 constituting a battery module on a lower shelf operates, a high-temperature gas is directly discharged to an upper shelf above the battery as shown in FIG. 4A. However, according to the battery 1 of the embodiment, when a safety valve (valve unit) of a battery 1 constituting a battery module on a lower shelf operates, a valve unit 22 guides the gas in a direction inclined at a predetermined angle θ with respect to a normal direction of a surface of a battery lid 20 of a battery container to discharge the gas to the outside as shown in FIG. 4B. Accordingly, the high-temperature gas is not directly discharged to an upper shelf above the battery 1, and as a result, it is possible to suppress a battery 1 disposed on the upper shelf from being heated to thus suppress the battery container made of aluminum from being melted. In addition, it is possible to prevent a chain reaction in which due to the heated battery 1, the internal pressure thereof increases, and thus the valve unit (safety valve) is caused to operate.

In addition, a fireproof plate 50 may be disposed on a side of a battery module constituted by a plurality of batteries 1 and valve units 22 of the plurality of batteries 1 may guide a gas generated in the battery container in a direction inclined at a predetermined angle toward the fireproof plate 50 to discharge the gas to the outside. When the fireproof plate 50 is provided in the gas discharge direction, the frame itself which forms the container is not directly heated, and deformation thereof and the like can be prevented. As the fireproof plate 50, for example, a steel plate having a thickness of 1.6 mm or greater can be used. However, the thickness and the material are not limited thereto, and may be appropriately selected as long as the fireproof plate has a fire-resistant property with respect to the gas.

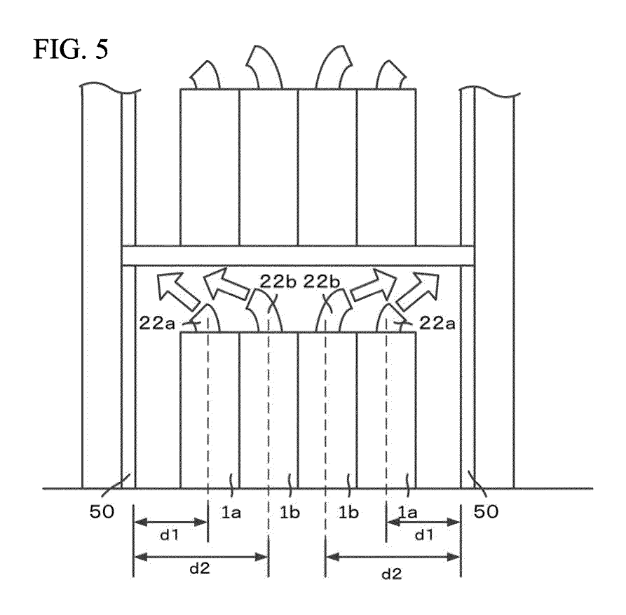

Furthermore, when a distance to the fireproof plate 50 of each of the batteries 1 varies depending on the disposition of the battery module, the respective valve units 22 of the batteries 1 may be designed so that the direction in which the gas is discharged to the outside may vary according to the distance to the fireproof plate 50. Specifically, when a battery la and a battery lb which are different in terms of the distance to the fireproof plate 50 are present (in the case of the battery 1a, a distance d1 to a fireproof plate 50, and in the case of the battery 1b, a distance d2 to a fireproof plate 50 (d1<d2)), the gas discharge directions of a valve unit 22a of the battery la and a valve unit 22b of the battery 1b can be inclined at 45° and 60°, respectively, as shown in FIG. 5. When the valve unit is designed so that the direction in which the gas is discharged to the outside varies according to the distance to the fireproof plate 50, it is possible to securely prevent the high-temperature gas from being directly discharged to the upper shelf.

### Modified Examples

As described above, the preferred embodiments of the battery and the battery system of the invention have been described. However, the invention is not limited to the above-described embodiments, and various modifications, additions, and omissions can be made by those skilled in the art without departing from the spirit and scope represented in the claims.

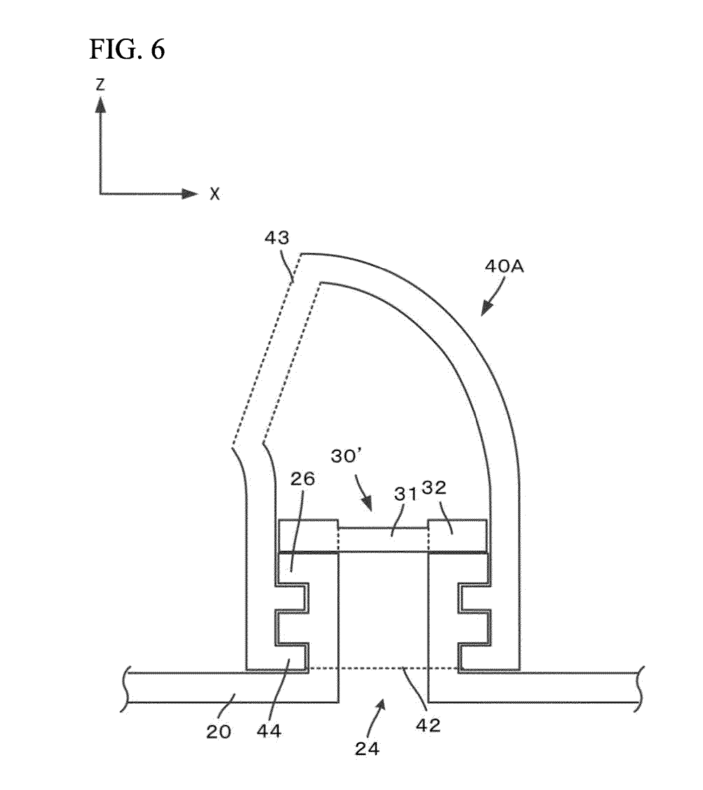

For example, in the above-described embodiments, the case in which the second joining section 33 of the break part 30 and the height 41 of the guide 40 are joined to each other, and thus the break part 30 and the guide 40 are joined to each other has been described as an example. However, the invention is not limited thereto, and the guide 40 may be directly joined to the battery lid 20. For example, as shown in FIG. 6, in a columnar protrusion which protrudes from the peripheral edge of the through hole 24 of the battery lid 20 to the outside of the battery container (+Z direction), a joining section (for example, male screw) 26 may be formed on an outer peripheral surface of the protrusion and a joining section (for example, female screw) 44 may be formed on an inner peripheral surface of a first end surface 42 of a guide 40A to join the guide 40A to the battery lid 20.

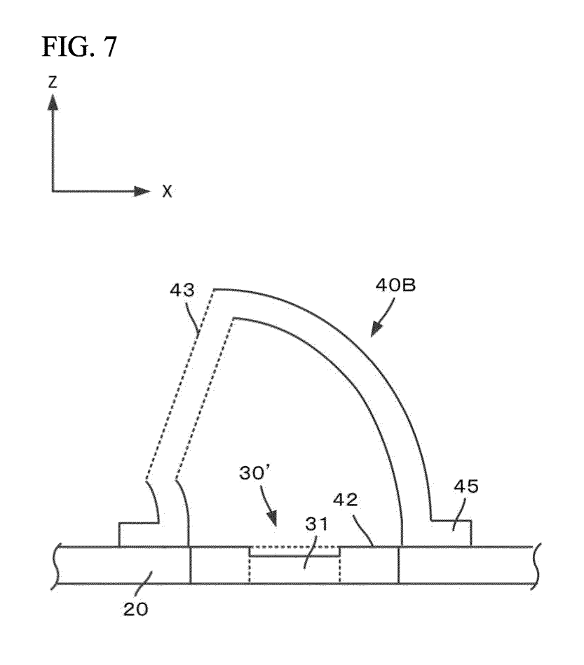

In addition, in the above-described embodiments, the case in which the protrusion 25 is provided from the peripheral edge of the through hole 24 of the battery lid 20 to the outside of the battery container to constitute the valve unit 22 has been described as an example. However, the invention is not limited thereto, and the guide 40 according to the embodiment may be directly joined and attached to the peripheral edge of the safety valve provided on a conventional battery to provide the valve unit of the invention. That is, as shown in FIG. 7, a joining section 45 for joining to the battery lid 20 may be provided at the peripheral edge of the first end surface 42 of a guide 40B to be joined to the peripheral edge of the safety valve of the battery lid 20 in the joining section 45. Even in the case of a conventional battery, when the valve unit can be constituted as described above, this is useful from the viewpoint of appropriate attachment according to the position of the battery.

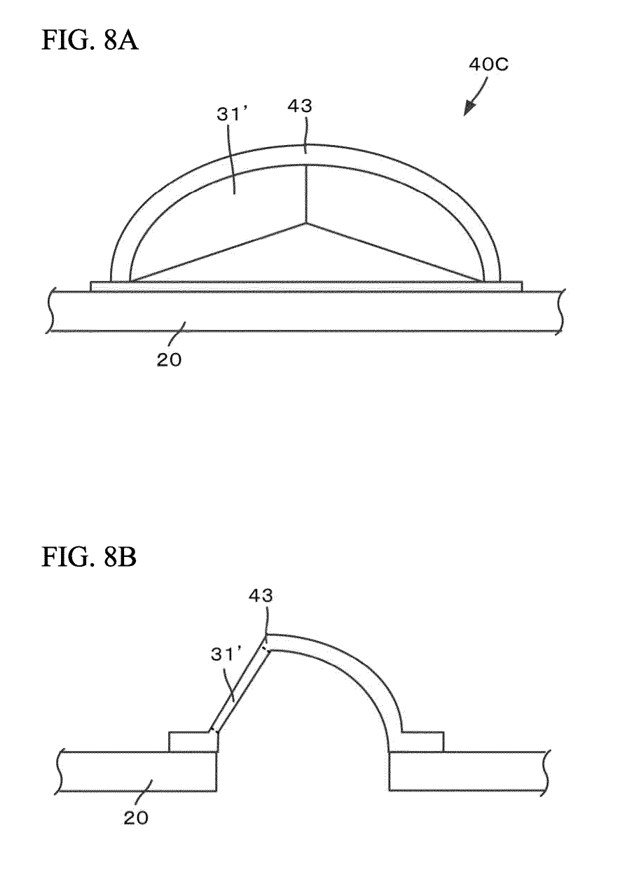

Furthermore, in the above-described embodiments, the case in which the break part 30 is provided parallel (or substantially parallel) to the surface of the battery lid 20 has been described as an example. However, the invention is not limited thereto. For example, as shown in FIGS. 8A and 8B, a guide 40C may be joined to the battery lid 20 and a break surface 31′ may be provided on the second end surface 43 facing the outside of the guide 40C.

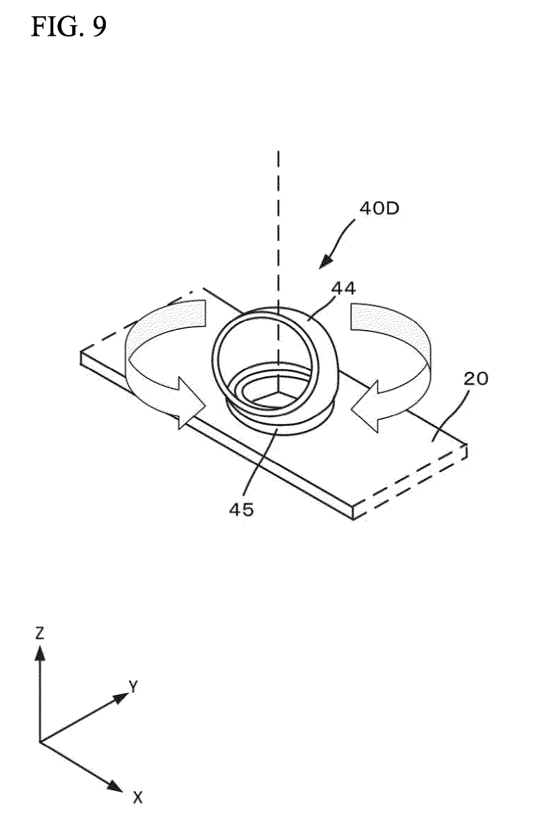

Furthermore, as shown in FIG. 9, in the battery 1 according to the above-described embodiments, a guide 40D may be constituted by a fixing unit 46 fixed to the battery lid 20 and a rotation unit 47 rotatable with respect to the fixing unit, and for example, the guide may be rotatable around the central axis of the first end surface 42. In this case, this is useful from the viewpoint of setting the gas discharge direction to an appropriate direction according to the circumstances such as a change of the position of the battery 1.

Furthermore, in the above-described embodiments, the case in which the battery lid 20 is provided with the break part 30 has been described as an example. However, the invention is not limited thereto. For example, the break part 30 may not be provided on the battery lid 20, but on a side surface of the battery container.

In the above-described embodiments, the lithium secondary battery has been described as an example of the battery. However, the invention is not limited thereto, and it is obvious to apply the invention to other batteries as long as the batteries are provided with a safety valve.

What is claimed is:

1. A battery comprising:
a valve unit which is disposed on a first surface of a battery container to be broken when a gas pressure in the battery container increases to a predetermined value or greater, so as to guide a gas in the battery container in a direction inclined at a predetermined angle with respect to a normal direction of the first surface to discharge the gas to the outside.

2. The battery according to Claim I,
wherein the valve unit includes a break part which seals a through hole formed on the first surface and is broken when the gas pressure in the battery container increases to a predetermined value or greater, and a guide which is formed into a tubular shape, protruding from a peripheral edge of the break part toward the outside of the battery container, in which an angle between central axes of both end surfaces is inclined at a predetermined angle, and guides the gas in the direction inclined at a predetermined angle to discharge the gas to the outside when the break part is broken.

3. The battery according to claim 2,
wherein the guide is detachably joined to the break part.

4. The battery according to claim 2,
wherein the guide is rotatable around the central axis of the first end surface.

5. The battery according to claim 3,
wherein the guide is rotatable around the central axis of the first end surface.

6. A battery system comprising:
a battery module which is constituted by a plurality of batteries, each of which is provided with a valve unit which is disposed on a first surface of a battery container to be broken when a gas pressure in the battery container increases to a predetermined value or greater, so as to guide a gas in the battery container in a direction inclined at a predetermined angle with respect to a normal direction of the first surface to discharge the gas to the outside; and
a fireproof plate which is disposed on a side of the battery module,
wherein the respective valve units of the plurality of batteries guide the gas generated in the battery container in a direction inclined at a predetermined angle toward the fireproof plate to discharge the gas to the outside.

7. The battery system according to claim 6,
wherein the respective valve units of the plurality of batteries are different from each other in terms of the direction in which the gas is discharged to the outside according to a distance to the fireproof plate.
